(19) United States
(12) Patent Application Publication
(10) Pub. No.: US 2008/0303917 A1
(43) Pub. Date: Dec. 11, 2008

(54) Digital processing cell

(76) Inventors: Felicia Shu, Waterloo (CA); Charles Smith, Waterloo (CA); Harald Siefken, Kitchener (CA); Lucian Ion, Waterloo (CA)

Correspondence Address: Fisher Technology Law, 40452 Hickory Ridge Place, Aldie, VA, 20105, US

(21) Appl. No.: 12/228,119

(22) Filed: Aug. 8, 2008

Related U.S. Application Data
(62) Division of application No. 10/406,286, filed on Apr. 4, 2003, now abandoned.
(60) Provisional application No. 60/369,556, filed on Apr. 4, 2002.

(51) Int. Cl. H04N 5/228

(52) U.S. Cl. 348/222.1; 348/E05.031

(57) ABSTRACT

A method and apparatus of digital image processing that provides pixel based image correction. The method and apparatus provide a digital processing cell that includes first and second processing modules. Each processing module includes a gate array. The gate array includes a digital video processing module and a switch portion configured to couple the digital video processing module to at least one of primary and secondary video buses and to couple the digital video processing module to at least one of primary and secondary neighborhood buses. An image processing system includes a plurality of such digital processing cells and an image sensor that outputs image data. The digital processing cells process the output image data.

The priority benefit of the Apr. 4, 2002 filing date of provisional application 60/369,556 is hereby claimed.

### BACKGROUND OF THE INVENTION

1. Field of the Invention

The present invention relates to digital signal processing of image data from a digital cinematography camera. In particular, the invention relates to a digital processing cell, as a module of a system that post processes image data from a solid state imaging sensor into high-quality cinema imagery that compares to film photography.

2. Description of Related Art

Various digital signal processing functions are required to act on image data produced in a digital camera. These functions include but are not limited to correction of inherent non-uniformities, performing image storage formatting (compression) and coding color information. These functions are best performed on an entire frame of image data at a time. The frame rate and resolution of cameras suitable for digital cinema combine to require extremely high data rates thus requiring significant levels of digital processing power which was previously not feasible in hardware in real-time. These operations were previously handled in software residing on high-end workstations and even then the process was quite slow.

Conventional approaches utilize offline non-realtime software processing or configurations of parallel processing hardware boards or both. These approaches result in either very slow (in the case of software) or very large (in the case of hardware) implementations that have no practical use.

### SUMMARY OF THE INVENTION

High-quality, high-resolution images are necessary for digital cinematography cameras and film scanners. The present processing cell architecture enables the large amount of digital image processing needed to provide the required level of image quality in a compact design in real-time. This has been a major hurdle to a practical implementation that has not previously been overcome by others trying to design cameras meeting the required performance. Image processing accelerators are required for image processing workstations and video servers. This cell architecture may be integrated into other products for back end processing of digital cinema image data.

This hardware implementation is more compact, lower cost and enables real-time processing resulting in improved workflow efficiencies and real-time feedback of image content to the user, at least as compared to software technology.

A novel expandable, compact, digital image processing architecture (Digital Processing Cell) is proposed for processing high-resolution images in real-time. The architecture preferably comprises DSPs, FPGAs, SDRAM devices, high-speed data serializers/deserializers (SerDes), various buffers, and a novel programmable switched bus system enabling the connection of an nearly unlimited number of cells to achieve the processing power required by any high-speed digital image processing system. A feature of the cell is the switched bus design that enables bidirectional high-speed routing of data to the various sections of the cell required by the operation being applied to the data.

These and other advantages are achieved, for example, by a digital processing cell that includes first and second processing modules. Each processing module includes a gate array. The gate array includes a digital video processing module and a switch portion configured to couple the digital video processing module to at least one of primary and secondary video buses and to couple the digital video processing module to at least one of primary and secondary neighborhood buses. An image processing system includes a plurality of such digital processing cells and an image sensor that outputs image data. The digital processing cells process the output image data.

Likewise, these and other advantages are achieved, for example, by a digital processing cell. The digital processing cell includes means for managing data flow between gate arrays, memories and a signal processor, means for stitching together data from separate data streams, and means for processing first and second separate modules of an algorithm. The means for processing processes the first separate module in a gate array and processes the second separate module in the signal processor. An image processing system includes a plurality of such digital processing cells and an image sensor that outputs image data. The digital processing cells process the output image data.

Further, these and other advantages are achieved, for example, by a method of digital image processing. The method includes the steps of managing data flow between gate arrays, memories and a signal processor in a digital processing cell, stitching together image data from separate data streams, and processing first and second separate modules of an algorithm. The processing step includes processing the first separate module in a gate array in the digital processing cell and processing the second separate module in the signal processor in the digital processing cell.

Additionally, these and other advantages are achieved, for example, by a digital image processing method that provides pixel based image correction. The method includes the steps of a first sub-module of a digital processing cell receiving a first set of pixels, the first sub-module processing the received first set of pixels, and duplicating a sub-set of the first set of pixels over a neighborhood bus. The neighborhood bus routs data between the first sub-module and a second sub-module of the digital processing cell. The method further includes the second sub-module receiving a second set of pixels and the second sub-module processing the received second set of pixels. The received second set of pixels includes the duplicated sub-set of the first set of pixels.

### BRIEF DESCRIPTION OF DRAWINGS

The invention will be described in detail in the following description of preferred embodiments with reference to the following figures wherein:

FIG. 1 is a block diagram of a dual channel processing cell;

FIG. 2 is a block diagram of a dual channel processing cell with interconnect buses;

FIGS. 3-10 are schematic diagrams exemplary of the video flow in a dual channel processing cell; and

FIG. 11 is a block diagram of another dual channel processing cell.

### DETAILED DESCRIPTION OF PREFERRED EMBODIMENTS

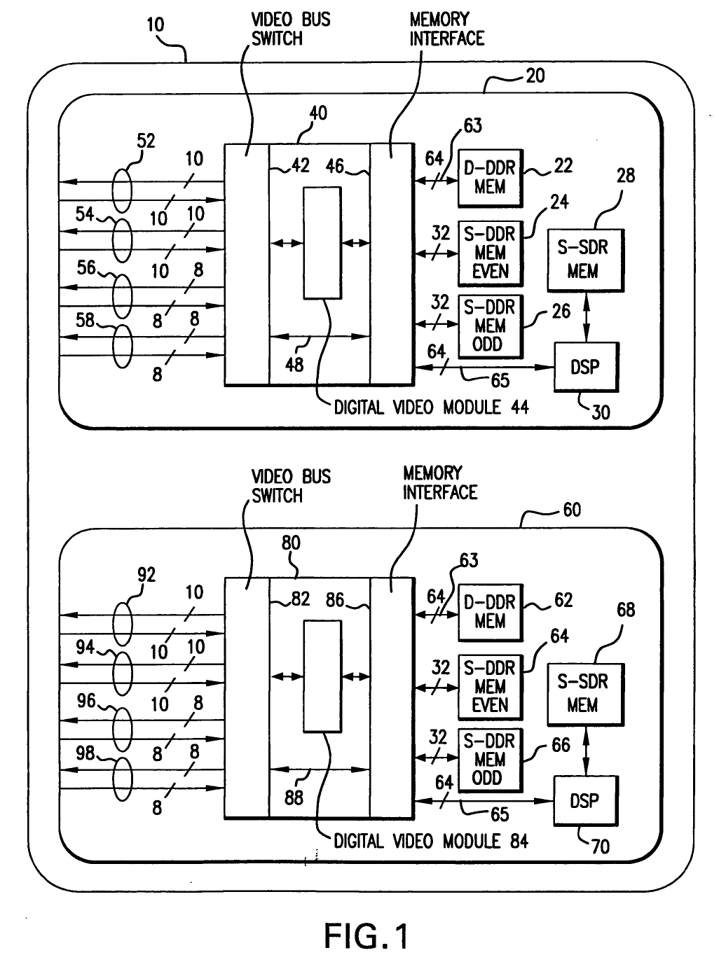

With reference to FIG. 1, generic data processing cell 10 performs digital image processing inside a high-resolution, high frame rate digital camera, image processing workstation, or video server. The cell configuration in one embodiment includes two high-density Field Programmable Gate Arrays (FPGA) 40, 80, two Digital Signal-Processing (DSP) devices 30, 70, several Dynamic Random Access Memory (DRAM) devices 22, 24, 26, 28, 62, 64, 66, 68 and a programmable, bi-directional switched bus architecture 42, 44, 46, 48, 82, 84, 86, 88 to enable data flow between two or more processing cells. This switched bus feature enables the expansion of the processing power available to the system as desired through parallel and/or layered expansion and includes primary and secondary video buses 52, 54, 92, 94 and primary and secondary neighborhood buses 56, 58, 96, 98. Future expansion to a third bus is a variant of the invention. The cell 10 also allows for data to be output to a number of targets such as a system CPU board, other data processing engines or data interface/formatting boards in other processing workstations or equipment.

To produce the high-quality images required in demanding applications employing high-resolution, high frame rate cameras, various digital signal processing functions are required to act on the image data produced in the camera. These functions include correction for non-linearity of the output signal caused by component tolerances in the video chain, correction for variability in pixel photo-response, calibration and matching of gain applied to multiple video paths, calibration and matching of digital offsets known as “dark offsets” in multiple video paths, replacement of missing image data resulting from dead pixels on the image sensor in signal, cluster, row or column groupings, coding of color information derived from the response and arrangement of the color filter on the image sensor and compression of image data to optimize storage formats and utility. These are the basic correction functions required but there are a plethora of digital filters and image attribute adjustment algorithms that may be employed to expand the features and functionality of the camera that can also be utilized in this processing cell 10. The described processing cell 10 enables the implementation of any or all of these processing functions in a real-time hardware solution that is compact and readily integrated into a high-performance digital camera, workstation or video server.

In an embodiment of the invention, each processing cell 10 includes two sub-modules 20, 60 each having an FPGA 40, 80, a DSP device 30, 70, and associated memory devices 22, 24, 26, 28, 62, 64, 66, 68. To increase flexibility and optimize performance, the architecture allows an algorithm (or portion of it) to be shifted from the FPGA 40, 80 to the DSP devices 30, 70 and vice versa. In this embodiment, the data bus control is implemented in a portion of the FPGA 40, 80 configured to control data distribution. The DSP 30, 70 and the memory devices 22, 24, 26, 28, 62, 64, 66, 68 are optional depending on the level of image data processing required in the system. This enables an even more compact implementation of the cell 10 for any application where space or power is at a premium.

In an embodiment with a full configuration as shown in FIG. 1, the Dual, Double Data Rate (D-DDR) SDRAM memory devices 22, 62 provide 32 MB of storage (4M×32 bit) for pixel coefficients for various processing algorithms. The other four Single, Double Data Rate (S-DR) SDRAM devices 24, 26, 64, 66 (labeled “odd” and “even”) each provide 16 MB of frame buffer (4M×32 bit), one pair for each pairing of the image processing FPGAs 40, 80 and DSP devices 30, 70. One frame buffer (e.g., SDRAM 24) is used to store a frame of data while the DSP (e.g., DSP 30) is processing the data from the alternate frame buffer (e.g., SDRAM 26). In this way, data access conflicts are eliminated. The DSP 30, 70 is directly connected to the FPGA 40, 80, and the FPGA 40, 80 manages memory and device interface incompatibilities. This is arranged this way because the DSP in the present embodiment has an SDR (single data rate) memory interface while the memory devices used to store either frame data or algorithm coefficients are DDR devices. The DSP may be directly connected to the frame buffers in future embodiments as next generation devices become available, such as DDR DSP devices, and the entire cell can process at the same rate. An additional S-SDR device 28, 68 is shown connected directly to the DSP device 30, 70 and may be used to store additional frame-based processing capacity, if required.

The cell 10 also includes a control bus (not shown) to enable a host system 209 to control the cell 10 as well as to enable communication of status information from the cell to the host system 209.

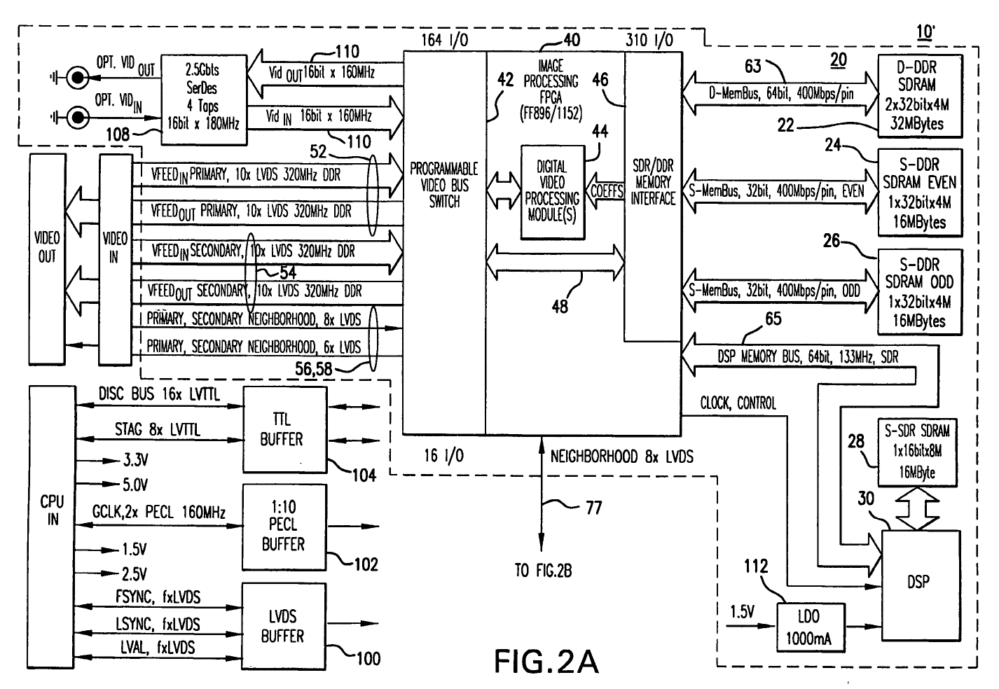

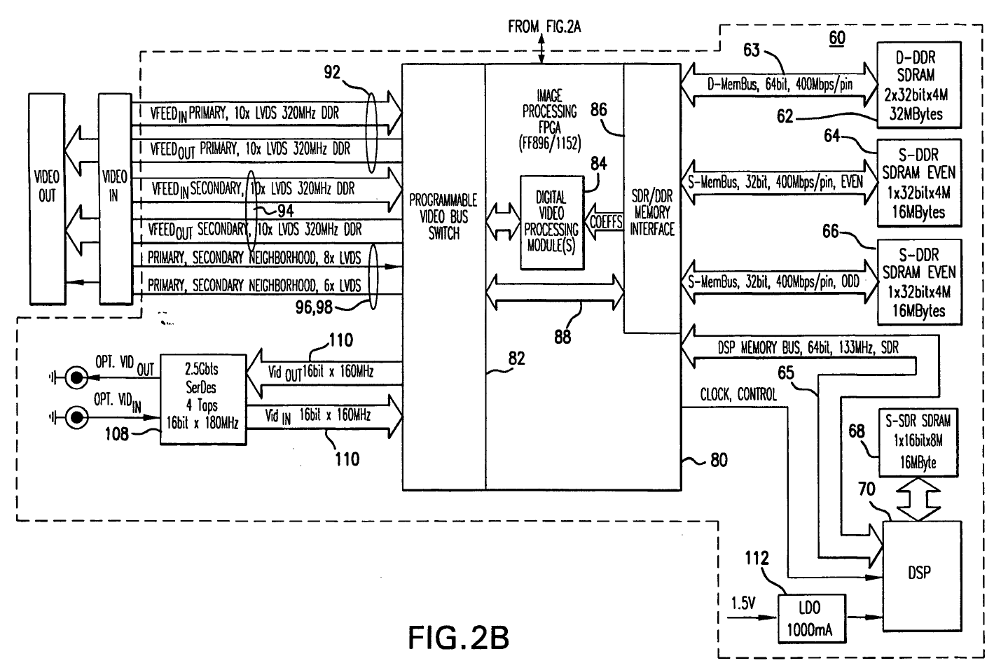

In FIG. 2, an alternative embodiment of the processing cell 10′ further includes a low voltage differential signal (LVDS) Buffer 100, an emitter coupled logic (PECL) buffer 102 for a high speed clock signal, and a TTL buffer 104 for other control signals. The LVDS Buffer 100 amplifies frame and line synchronization signals and a line valid signal. The embodiment of FIG. 2 further includes a serializer-deserializer circuit (Ser/Des) 108 for each sub-module (e.g., sub-modules 20, 60). The Ser/Des 108 may be, for example, a 16 bit×160 MHz circuit with 4 taps and a data rate of 2.5 Gb/s. The deserializer of the Ser/Des 108 converts a high speed serial signal (Vid_{IN}) from, for example an industry standard SMA connector, into a high speed parallel digital data bus 110 (e.g. 18 bits by 160 MHz, million word samples per second). The serializer of the Ser/Des 108 converts a high speed parallel digital data bus 110 (e.g., 18 bits by 160 MHz, million word samples per second) into a high speed serial signal (Vid_{OUT}) for feed to, for example an industry standard SMA connector. Optionally, the serializers-deserializers 108 depicted in FIG. 2 could be embedded in the FPGA devices (e.g., FPGAs 40, 80) for a more compact implementation. When multiple processing cells (e.g., processing cells 10, 10′) are connected together, the serializer/desirializer buses 110 can be used for inter-cell data transfer to further increase the bandwidth and simplify data management. The embodiment of FIG. 2 further includes LDO power supply conditioners 112 (e.g., 1000 mA) for special circuits such as the DSP 30, 70.

The embodiment of FIG. 2 also further includes a tertiary neighborhood bus 77 coupled to the FPGA 40 of the first processing module 20 and the FPGA 80 of the second processing module 60. Tertiary neighborhood bus 77 is a direct bus between the FPGAs 40, 80, preferably used for carryover between the FPGAs 40, 80.

In operation, video is received into or read out of the cell 10′ from either the primary and secondary low voltage differential signal (LVDS) video buses 52, 54, 92, 94 (e.g., 10×, 320 MHZ DDR) or via the SMA connectors and the serializer/deserializer (SerDes) chips 108 (see FIG. 2). From here, data can be routed either to the digital video processing modules 44, 84 within the FPGA 40, 80, directly to the SDR/DDR memory interface 46, 86 via bus 48, 88 or to other processing cells 10, 10′ in the system. This enables a myriad of processing options such as:

parallel processing of different portions of frame data by multiple cells,

parallel processing of same frame data by multiple cells,

parallel deployment of a single algorithm across multiple cells to increase speed,

deployment of discrete portions of an algorithm across multiple cells to increase speed (i.e., daisy-chaining the processing),

bi-directional data flow between the appropriate devices for processing within a cell,

bi-directional data flow between the appropriate devices for processing between cells,

routing of algorithm coefficients to the memory blocks during power up.

The management of these various data paths and video I/O ports is accomplished by the programmable bus switch 42, 82 implemented within the FPGA 40, 80. The programmable bus switch 42, 82 manages the data flow between the FGPAs, memories and the digital signal processors.

For example, the digital processing module 44 receives data from the video bus switch 42 and coefficients from the memory interface 46. A number of basic correction algorithms act on the data in the digital processing module 44 and the data is then sent back to the memory interface 46 and written to one of the frame buffers 24. The DSP 30 then performs some further function on that frame, while the FPGA 40 writes to the other frame buffer 26. The FPGA 40 then grabs the data from the first frame buffer 24 and performs the first portion of, for example, a compression algorithm and re-writes the data back to the same buffer 24. The DSP 30 accesses that data and performs the second portion of the compression algorithms before it sends the data back to the FPGA 40 where it is serialized (e.g., in Ser/Des 110) and sent out through switch 42 of the FPGA 40 to the LVDS board-to-board interconnect bus 52 or 54. This is an example of data flow management that enables parallel processing and optimized distribution of correction algorithms or portions thereof.

The memory interface 46, 86 is also implemented within the FPGA 40, 80 and has a bi-directional connection 48, 88 to the video bus switch 42, 82 to exchange data. In addition to sending coefficients to the video processing blocks 44, 84 in the FPGA 40, 80, the FPGA 40, 80 manages at least 2 memory interface standards. An initial implementation will manage DDR for up to 200 MHz clock rates and SDR up to 133 MHz. As before, different embodiments will be enabled as next generation components (e.g., DDR DSPs) become available.

For example, the interface 65 from the FPGA 40, 80 to the DSP 30, 70 is essentially a memory interface. The 133 MHz clock rate that the DSP 30, 70 can sustain is supported by the FPGA 40, 80. The FPGA 40, 80 has the additional task of managing the interface between the SDR DSP 30, 70 and the DDR memory interface 63. The bandwidth of this interface 63 is 133 MHz×8 Byte or roughly 1 Gbyte/s.

The D-DDR configuration 22, 62 shown provides a total of 32 Mbytes for storage of all pixel based coefficients. The memory 22, 62 provides a total bandwidth of 2×200 MHz×64 Bit, or 3.2 Gbyte/s bandwidth.

The S-DDR memory 24, 26, 64, 66 is used as a 16 MB frame buffer and its bandwidth is currently 1.6 Gbyte/s. In some cases, there may be a requirement to alternate read and write operations. Refresh of the SDRAM memory 24, 26, 64, 66 can be done between frames but may not be required depending on how long the frame is buffered for. The amount of available memory will likely be an advantage when alternate read and write operations are required.

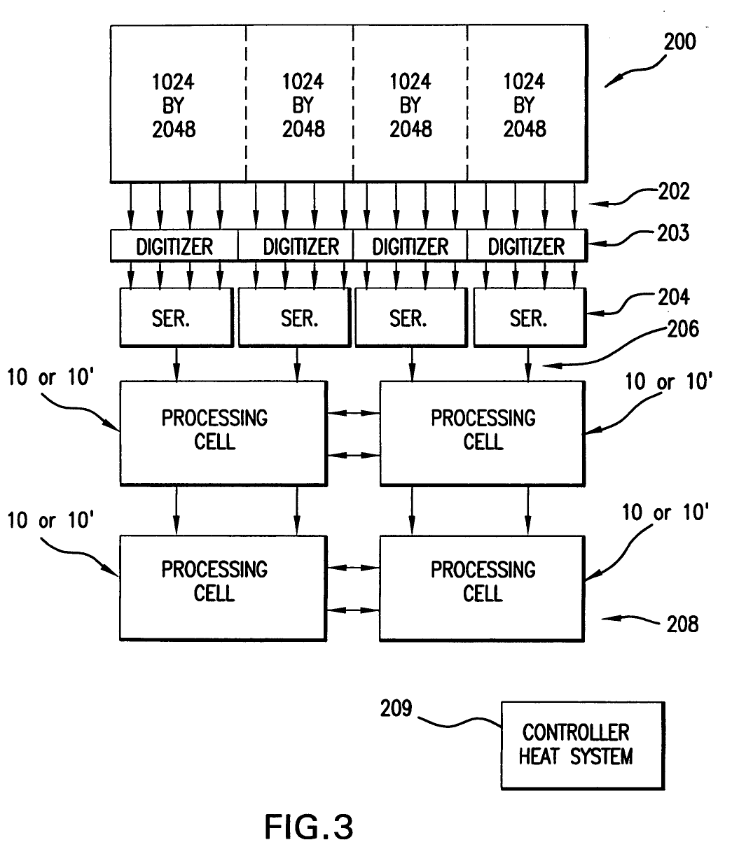

In a typical application, as depicted in FIG. 3, the image is captured with a silicon image sensor 200 that has a 16 tap readout register appearing as 16 parallel outputs 202, or channels, each corresponding to a one-sixteenth segment of the image captured on the imaging surface (in this example, 1024 by 2048 pixels or 256×2048 pixels per channel). In this example, the 16 sensor outputs are grouped into four groups of 4 outputs each. Each sensor output signal is conditioned and digitized by digitizers 203, and then serialized by a serializer 204 into a corresponding serial data stream 206 and feed into a processing cell 10, 10′, two data streams (for each sub-module 20, 60) per processing cell. Processing algorithms ensure that seams between channels are not visible (as discussed below) and that the performance of each channel is consistent with the other 15 channels. A single processing cell 10, 10′ can process up to 8 channels simultaneously, 4 within each FPGA/DSP sub module 20, 60, thus a minimum of 2 processing cells 10, 10′ are required to process the complete image. When the required processing speed requires further processing, parallel video buses enable data to passed along, pipeline fashion to another layer of processing 208. The digital processing cells 10, 10′ shown FIG. 3, therefore, are coupled together in a pipeline configuration in which the data is passed to and processed in each layer of processing cells 10, 10′ simultaneously (in parallel).

Another function performed by the processing cell 10, 10′ is the merging or “stitching” together of data from separate data streams, otherwise known as “neighborhood” processing. Some of the signal processing algorithms require neighborhood data from the adjacent channel to be shared to create an overlap where the channels separate. This overlap will occur between channels within a sub module 20, 60, between sub modules 20, 60 within a cell 10, 10′, and between processing cells 10, 10′. The primary and secondary neighborhood buses 56, 58, 96, 98 are implemented specifically to distribute this type of shared data.

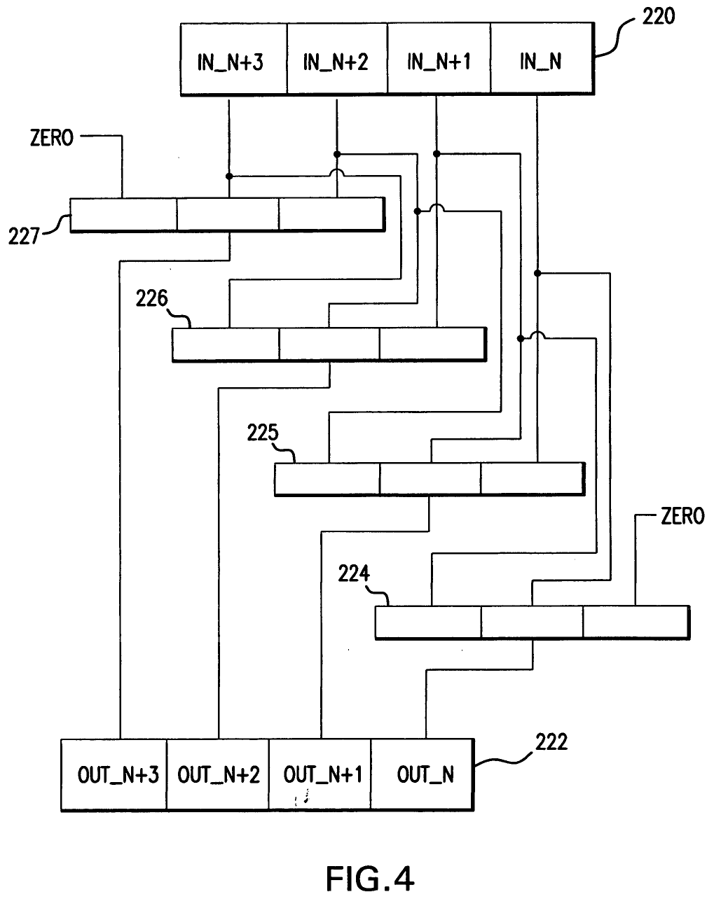

FIG. 4 provides a simplified example of the processing of a 4 pixel wide channel of data. In FIG. 4, 4 pixel wide input array 220 is processed into 4 pixel wide output array 222. In this example, a low pass filter is illustrated as filters 224 through 227. Filter 225, for example, sums (or averages) the pixel values in input array pixels N, N+1 and N+2, and then outputs the summed value to output array pixel N+1. Similarly, filter 226 sums (or averages) the pixel values in input array pixels N+1, N+2 and N+3, and then outputs the summed value to output array pixel N+2. However, filters 224 and 227 have a problem with this kind of processing. Within the 4 pixel wide processing cell, there are no pixel values for input array pixels N−1 and N+4, and thus, a Zero is input to the filters instead of the true values. This causes the values processed in the output array for pixels N and N+3 to be in error.

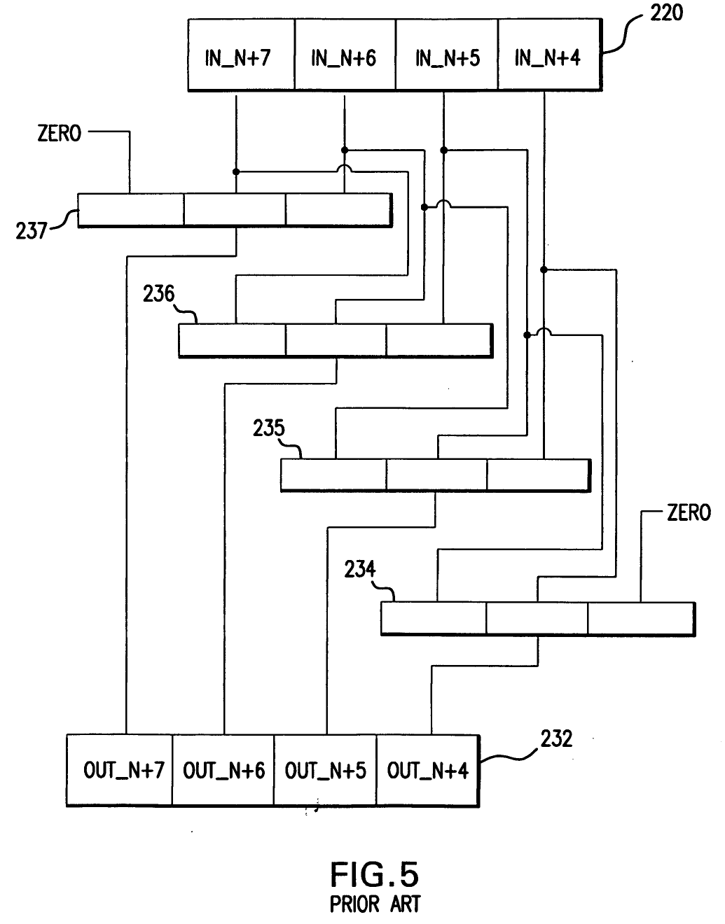

Loosing the edge pixel of a linear array is bad enough; however, known processing techniques merely concatenate and repeat the same type of channel processing for the next adjacent channel leaving a two pixel wide strip of inaccurate data in the center of an 8 pixel wide array. FIG. 5 depicts a known process for processing a concatenated adjacent 4 pixel wide channel of data (adjacent to the process depicted in FIG. 4). In FIG. 5, 4 pixel wide input array 230 is processed into 4 pixel wide output array 232. In this example, a low pass filter is illustrated as filters 234 through 237. Filter 235, for example, sums (or averages) the pixel values in input array pixels N+4, N+5 and N+6, and then outputs the summed value to output array pixel N+5. Similarly, filter 236 sums (or averages) the pixel values in input array pixels N+5, N+6 and N+7, and then outputs the summed value to output array pixel N+6. However, as in FIG. 4, filters 234 and 237 have a problem with this kind of processing. Within this 4 pixel wide processing cell, there are no pixel values for input array pixels N+3 and N+8, and thus, a Zero is input to the filters instead of the true values. This causes the values processed in the output array for pixels N+4 and N+7 to be in error. The two concatenated processing cells (each 4 pixels wide), FIGS. 4 and 5, produce an 8 pixel wide output array. However, pixels N, N+3, N+4 and N+7 have data values in error leaving a strip of inaccurate data in the middle of the 8 pixel wide output array (i.e., pixels N+3 and N+4) in addition to edge pixels N and N+7.

In the present example, two groups of 4 pixels each are processed. In the known process (FIGS. 4 and 5) as discussed above, the lowest numbered 4 pixels (N through N+3) are processed in one processing cell according to FIG. 4, and the highest numbered pixels (N+4 through N+7) are processed in another processing cell according to FIG. 5.

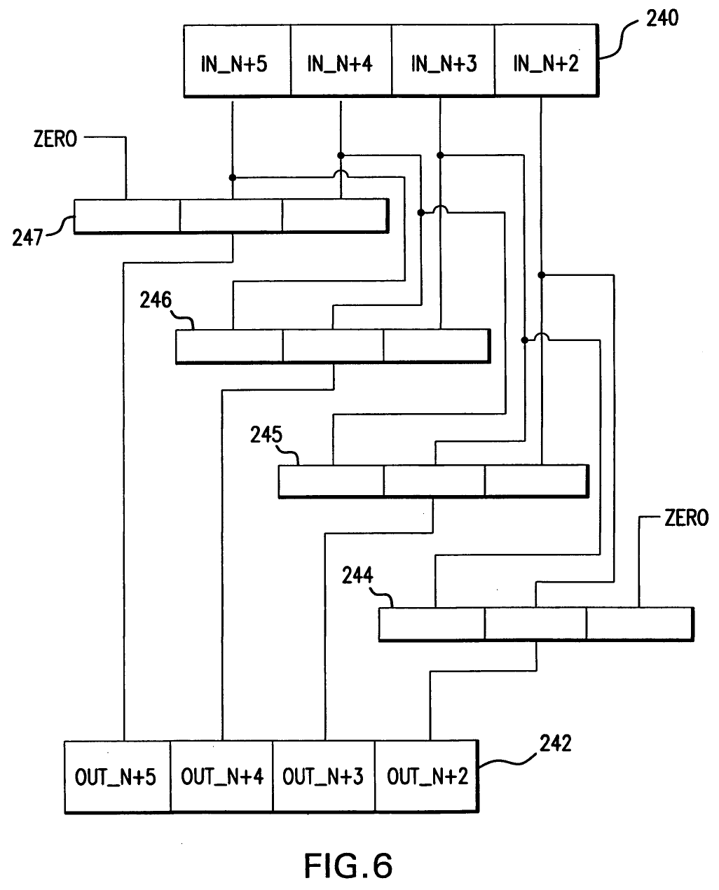

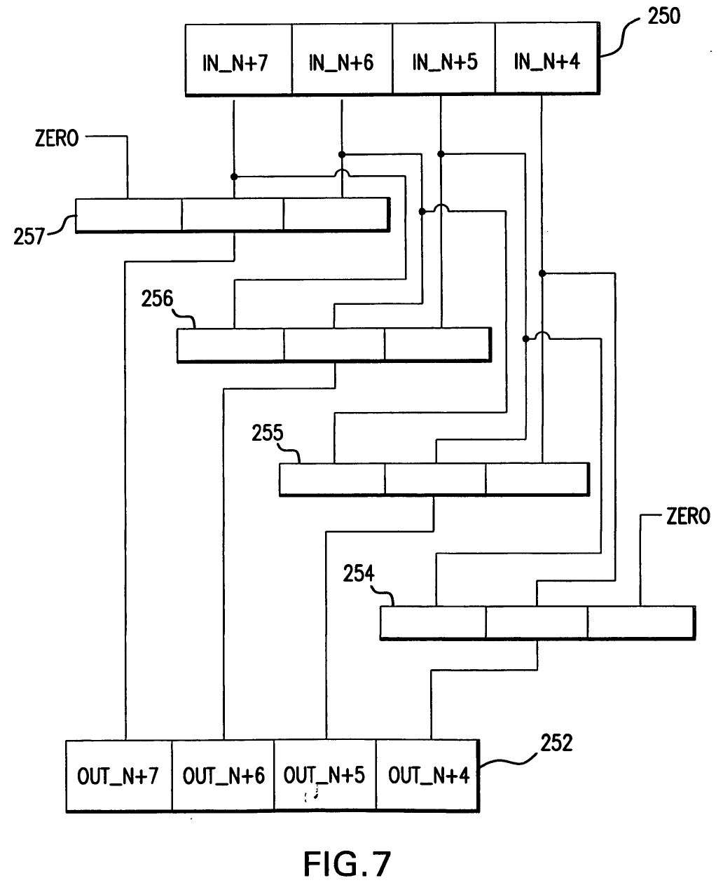

In contrast, in the present embodiment, the lowest numbered 4 pixels (N through N+3) are processed in a first processing cell 10, 10′ according to FIG. 4, the middle numbered pixels (N+4 and N+5) are processed in a second cell 10, 10′ according to FIG. 6, and the highest numbered pixels (N+6 and N+7) are processed in a third cell 10, 10′ according to FIG. 7. With the processing depicted in FIGS. 4, 6 and 7, improved processing is achieved and edge artifacts (that would otherwise appear in the center of the array) are removed.

In FIG. 6, 4 pixel wide input array 240 is processed into 4 pixel wide output array 242 in a process similar to the processing depicted in FIG. 4. In this example, a low pass filter is illustrated as filters 244 through 247. Filter 245, for example, sums (or averages) the pixel values in input array pixels N+2, N+3 and N+4, and then outputs the summed value to output array pixel N+3, and filter 246 sums (or averages) the pixel values in input array pixels N+3, N+4 and N+5, and then outputs the summed value to output array pixel N+4. As in FIG. 4, filters 244 and 247 still have a problem with this kind of processing. Within this 4 pixel wide processing cell, there are no pixel values for input array pixels N+1 and N+6, and thus, a Zero is input to the filters instead of the true values. This causes the values processed in the output array for pixels N+2 and N+5 (of FIG. 6) to be in error.

In FIG. 7, 4 pixel wide input array 250 is processed into 4 pixel wide output array 252 in a process similar to the processing depicted in FIGS. 4 and 6. In this example, a low pass filter is illustrated as filters 254 through 257. Filter 255, for example, sums (or averages) the pixel values in input array pixels N+4, N+5 and N+6, and then outputs the summed value to output array pixel N+5, and filter 256 sums (or averages) the pixel values in input array pixels N+5, N+6 and N+7, and then outputs the summed value to output array pixel N+6. As in FIG. 4, filters 254 and 257 still have a problem with this kind of processing. Within this 4 pixel wide processing cell, there are no pixel values for input array pixels N+3 and N+8, and thus, a Zero is input to the filters instead of the true values. This causes the values processed in the output array for pixels N+4 and N+7 (of FIG. 7) to be in error.

In the processing embodiment depicted in FIGS. 4 and 6, input array pixels N+2 and N+3 are processed both in the process depicted in FIG. 4 and in the process depicted in FIG. 6. These two pixels (pixels N+2 and N+3) are duplicated in both the highest numbered pixels in 4 pixel wide input array 220 (FIG. 4) and in the lowest number pixels in 4 pixel wide input array 240 (FIG. 6). This constitutes what is referred to as overlap in processing.

Similarly, in the processing embodiment depicted in FIGS. 6 and 7, input array pixels N+4 and N+5 are processed both in the process depicted in FIG. 6 and in the process depicted in FIG. 7. These two pixels (pixels N+4 and N+5) are duplicated in both the highest numbered pixels in 4 pixel wide input array 240 (FIG. 6) and in the lowest number pixels in 4 pixel wide input array 250 (FIG. 7). This also constitutes overlap processing.

Thus, in FIGS. 4, 6 and 7, there is a two pixel wide overlap between the processing of FIGS. 4 and 6, and a 2 pixel wide overlap between the processing of FIGS. 6 and 7. This is achieved by use of neighborhood buses 56, 58, 96, 98, as depicted in FIGS. 1 and 2, to transport pixel data between adjacent processing cells 10, 10′ or between sub-modules 20, 60 of a processing cell 10, 10′. The 4 lowest numbered pixels (N through N+3, the whole of a first set of 4 pixels) are processed in a first processing cell 10, 10′.

Then, a second processing cell 10, 10′ processes, as its lowest numbered two pixels, the two highest numbered pixels (N+2 and N+3) that are processed in the first processing cell (e.g., as duplicated over neighborhood buses) causing an overlap of two pixels. The next two numbered pixels (N+4 and N+6, a second set of 4 pixels less the highest number two pixels of the second set of 4 pixels) are also processed as the highest numbered pixels of the second processing cell. Of the second set of 4 pixels (N+4 through N+7), the highest number two pixels are not processed in the second processing cell.

Then, a third processing cell 10, 10′ processes, as its lowest numbered two pixels, the two highest numbered pixels (N+4 and N+5) that are processed in the second processing cell (e.g., as duplicated over neighborhood buses) causing an overlap of two pixels. The next two numbered pixels (N+6 and N+7, the highest number two pixels of the second set of 4 pixels) are also processed as the highest numbered pixels in the third processing cell.

Output array pixels numbered N+2 and N+3 are duplicated in the processing depicted in FIGS. 4 and 6; however pixel numbered N+3 in array 222 (FIG. 4), but not in array 242 (FIG. 6), may include an erroneous value, and pixel numbered N+2 in array 242 (FIG. 6), but not in array 222 (FIG. 4), may include an erroneous value. Similarly, output array pixels numbered N+4 and N+5 are duplicated in the processing of FIGS. 6 and 7; however pixel numbered N+5 in array 242 (FIG. 6), but not in array 252 (FIG. 7), may include an erroneous value, and pixel numbered N+4 in array 252 (FIG. 7), but not in array 242 (FIG. 6), may include an erroneous value. This process embodiment culls pixels N through N+2 from output array 222 (FIG. 4), pixels N+3 and N+4 from output array 242 (FIG. 6), and pixels N+5 through N+7 from output array 252 (FIG. 7) to make of an output array of 8 pixels with no erroneous values at processing cell edges (between processing cell boundaries). Pixels numbered N+3 in array 222 (FIG. 4), numbered N+2 in array 242 (FIG. 6), numbered N+5 in array 242 (FIG. 6), and pixel numbered N+4 in array 252 (FIG. 7) are discarded as they may include an erroneous value. The final result of this embodiment is a properly filtered array of 8 pixels with no strips of pixels with possibly erroneous values interior to the output array.

The single processing cell operating according to the process of FIG. 4 results in the output two edge pixels having corrupted data. However, the multiple processing cells 10, 10′ operating according to the process illustrated in FIGS. 4, 6 and 7, using neighborhood buses 56, 58, 96, 98 for an overlap of two pixels (two pixels in each adjacent cell are identical at the inputs), provides seamless boundaries between edges (a process referred to as stitching). While a three pixel wide low pass filter is illustrated, the same principals apply to any filter or processing operation that uses an input of more than a single pixel width to compute a pixel output. In fact, it is not uncommon to need processing widths of 8, 12 or 16 pixels for better image quality control.

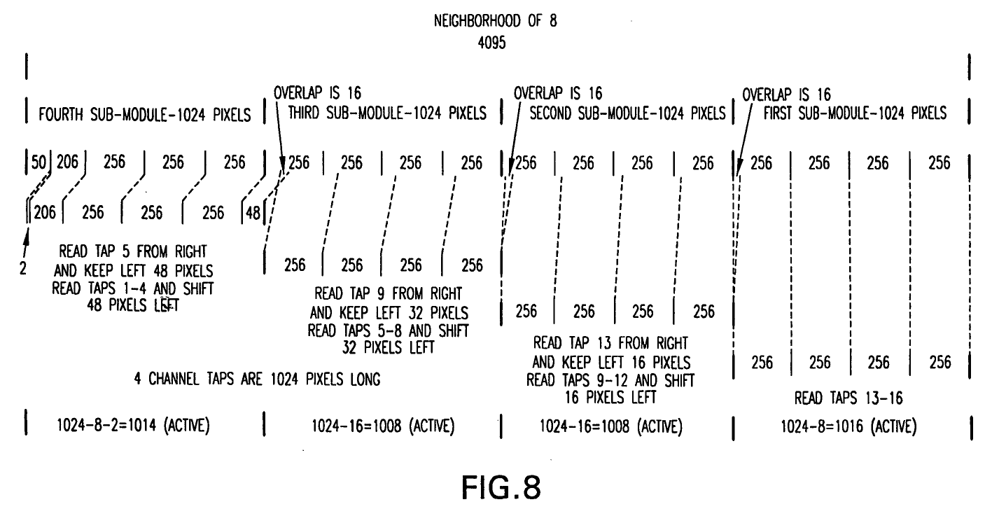

FIG. 8 illustrates processing for more practical sensors for neighborhood of 8 processing where the overlap is 16. In FIG. 8, an input array (analogous to 220, 240 or 250 in FIG. 4, 6 or 7) is 1024 pixels long. As illustrated in FIG. 3, exemplary sensor 200 has 16 taps 202 (e.g., 256 pixels per tap). Four taps are serialized in serializer 204 to provide a serial data stream of 1024 pixels from a single row of sensor 200. The serial data stream is transferred to one sub-module (20 or 60) within processing cell 10, 10′ (See FIG. 1 or 2).

Filtering or otherwise processing, as discussed above with respect to a 4 pixel wide input array processed according to FIG. 4, is performed on a 1024 pixel wide input array as described according to FIG. 8 where filters may be as wide as the neighborhood (e.g., plus or minus 8 pixels). The 1024 pixels of the input array represent 4 of the output taps from sensor 200 (FIG. 1), and these discrete output taps are illustrated as 256 pixel channels at the top of the neighborhood of 8 processing in FIG. 8. The 16 taps 202 are depicted in FIG. 3 from the left to the right and numbered from 1 to 16, respectively.

In FIG. 8, taps 13-16 form the 1024 pixels input array for the first sub-module (e.g., sub-module 20 in a first processing cell 10, 10′) for subsequent processing. Taps 9-12 basically form the 1024 pixel input array for the second sub-module for subsequent processing, but with taps 9-12 shifted 16 pixels left, with the leftmost 16 pixels of taps 9-12 deleted and with the 16 leftmost pixels of tap 13 copied from tap 13 over a neighborhood bus 56, 58, 96, 98 and concatenated on the right of the input array for the second sub-module (e.g., sub-module 60 in a first processing cell 10, 10′). Taps 5-8 basically form the 1024 pixel input array for the third sub-module (e.g., sub-module 20 in a second processing cell 10, 10′) for subsequent processing, but with taps 5-8 shifted 32 pixels left, with the leftmost 32 pixels of taps 5-8 deleted and with the 32 leftmost pixels of tap 9 copied from tap 9 over a neighborhood bus and concatenated on the right of the input array for the third sub-module. Taps 1-4 basically form the 1024 pixel input array for the fourth sub-module (e-g., sub-module 60 in a second processing cell 10, 10′) for subsequent processing, but with taps 1-4 shifted 48 pixels left, with the leftmost 48 pixels of taps 1-4 deleted (actually they are “dark” reference pixels) and with the 48 leftmost pixels of tap 5 copied from tap 5 over a neighborhood bus 56, 58, 96, 98 and concatenated on the right of the input array for the fourth sub-module.

After positioning the input arrays using neighborhood buses 56, 58, 96, 98, filtering or other processing is achieved. Then, the leftmost 8 pixels of the output array of the first sub-module is deleted keeping the right most 1016 pixels (1024−8) numbered N through N+1015 (1023−8). Of the 1024 pixels in the output array of the second sub-module, the leftmost 8 pixels and the rightmost 8 pixels are discarded keeping the center 1008 pixels (1024−16) numbered N+1016 (0+1016) through N+2023 (1015+1008). Of the 1024 pixels in the output array of the third sub-module, the leftmost 8 pixels and the rightmost 8 pixels are discarded keeping the center 1008 pixels (1024−16) numbered N+2024 (1016+1008) through N+3031 (2023+1008). Of the 1024 pixels in the output array of the fourth sub-module, the rightmost 8 pixels are discarded keeping the leftmost 1016 pixels (1024−8) numbered N+3040 (2024+1016) through N+4047 (3031+1016).

Thus, the four sub-modules in two processing cells (see FIG. 3) provides a total output array with pixels numbered N to N+4047 (4048 pixels wide) with no strip of corrupted data in the center of the output array. In the embodiment of FIG. 8, the sensor is assumed to have a total width of 4096 pixels with the leftmost 50 pixels covered from light to provide a dark reference signal. Therefore, the leftmost two pixels (pixels numbered N+4046 and N+4047) of the output array are actually dark pixels and contain only the dark reference signal. Neighborhood buses 56, 58, 96, 98 between the two sub-modules 20, 60 of processing cell 10, 10′ and between adjacent processing cells enable the processing structure of FIG. 8 to be implemented.

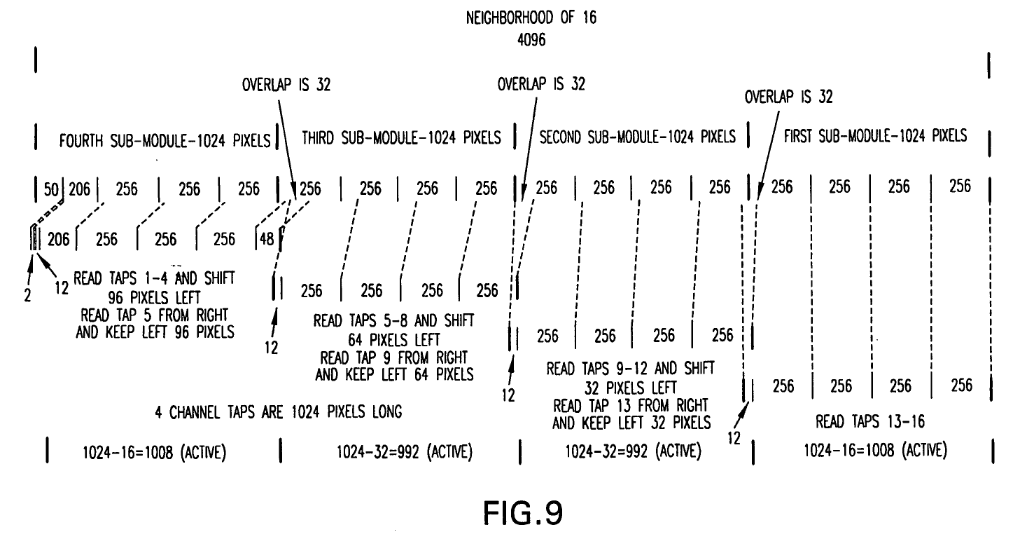

Similarly, in FIG. 9, taps 13-16 form the 1024 pixels input array for the first sub-module for subsequent processing. Taps 9-12 basically form the 1024 pixel input array for the second sub-module for subsequent processing, but with taps 9-12 shifted 32 pixels left, with the leftmost 32 pixels of taps 9-12 deleted and with the 32 leftmost pixels of tap 13 copied from tap 13 over a neighborhood bus and concatenated on the right of the input array for the second sub-module. Taps 5-8 basically form the 1024 pixel input array for the third sub-module for subsequent processing, but with taps 5-8 shifted 64 pixels left, with the leftmost 64 pixels of taps 5-8 deleted and with the 64 leftmost pixels of tap 9 copied from tap 9 over a neighborhood bus and concatenated on the right of the input array for the third sub-module. Taps 1-4 basically form the 1024 pixel input array for the fourth sub-module for subsequent processing, but with taps 1-4 shifted 96 pixels left, with the leftmost 96 pixels of taps 14 deleted (actually they are “dark” reference pixels) and with the 96 leftmost pixels of tap 5 copied from tap 5 over a neighborhood bus and concatenated on the right of the input array for the fourth sub-module.

After positioning the input arrays using neighborhood buses, filtering or other processing is achieved. Then, the leftmost 16 pixels of the output array of the first sub-module is deleted keeping the right most 1008 pixels (1024−16) numbered N through N+1007 (1023−16). Of the 1024 pixels in the output array of the second sub-module, the leftmost 16 pixels and the rightmost 16 pixels are discarded keeping the center 992 pixels (1024−32) numbered N+1008 (0+1008) through N+1999 (1007+992). Of the 1024 pixels in the output array of the third sub-module, the leftmost 16 pixels and the rightmost 16 pixels are discarded keeping the center 992 pixels (1024−32) numbered N+2000 (1008+992) through N+2991 (1999+992). Of the 1024 pixels in the output array of the fourth sub-module, the rightmost 16 pixels are discarded keeping the leftmost 1008 pixels (1024−16) numbered N+3008 (2000+1008) through N+3999 (2991+1008).

Thus, the four sub-modules in two processing cells (see FIG. 3) provides a total output array with pixels numbered N to N+3999 (4000 pixels wide) with no strip of corrupted data in the center of the output array. In the embodiment of FIG. 9, the sensor is assumed to have a total width of 4096 pixels with the leftmost 50 pixels covered from light to provide a dark reference signal. Neighborhood buses between the two sub-modules of processing cell 10 and between adjacent processing cells enable the processing structure of FIG. 9 to be implemented.

Specific examples of this type of processing are provided in FIGS. 8 and 9 below. However, by extension, neighborhood of 24 and neighborhood of 32 processing (or any practical neighborhood) may also be implemented. The image sensor used in the examples has 50 dark pixels at the beginning of the frame and 48 are utilized to minimize the data flow between cells 10, 10′ and to keep the data channels to the smallest possible size. With a neighborhood of <24 pixels (total of 48 between two channels) the shared data between any 4 channels only flows in one direction, while a neighborhood of >24 pixels requires data to flow in both directions simultaneously around channels 8 and 9 utilizing the bi-directionality of the bus 56, 58, 96, 98. Relative to the overall bandwidth of the cell 10, 10′ the bandwidth requirement for this operation is low, however, the data handling is complex and the frame needs to be stitched together properly to avoid introducing artifacts.

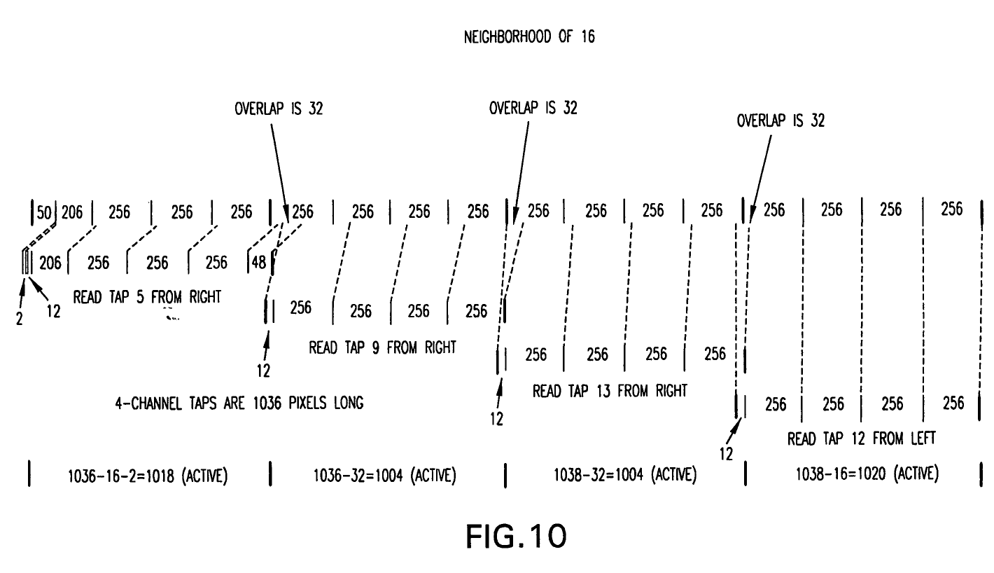

The number of pixels required in the neighborhood may vary from algorithm to algorithm depending on the performance required for that particular parameter. For a neighborhood greater than 8 pixels (e.g., 16, 24, 32, etc.), as an alternative to discarding valid pixels from the left of the array, the channel width is increased beyond 1024 pixels (e.g., to 1040 pixels, 1048 pixels, or 1056 pixels, etc.). In this case, all of the 4096 valid pixels can be preserved at the expense of increased channel complexity. FIG. 10 illustrates an example alternative in which the channel width is increased to 1036 pixels for a neighborhood of 16 pixels. As shown, there is a sum of 4046 active pixels in this alternative.

The flexibility afforded by this architecture allows a number of variations ranging from the full configuration shown in FIG. 2 to any number of partial implementations depending on the required processing power. The “best” implementation will be dictated by the application.

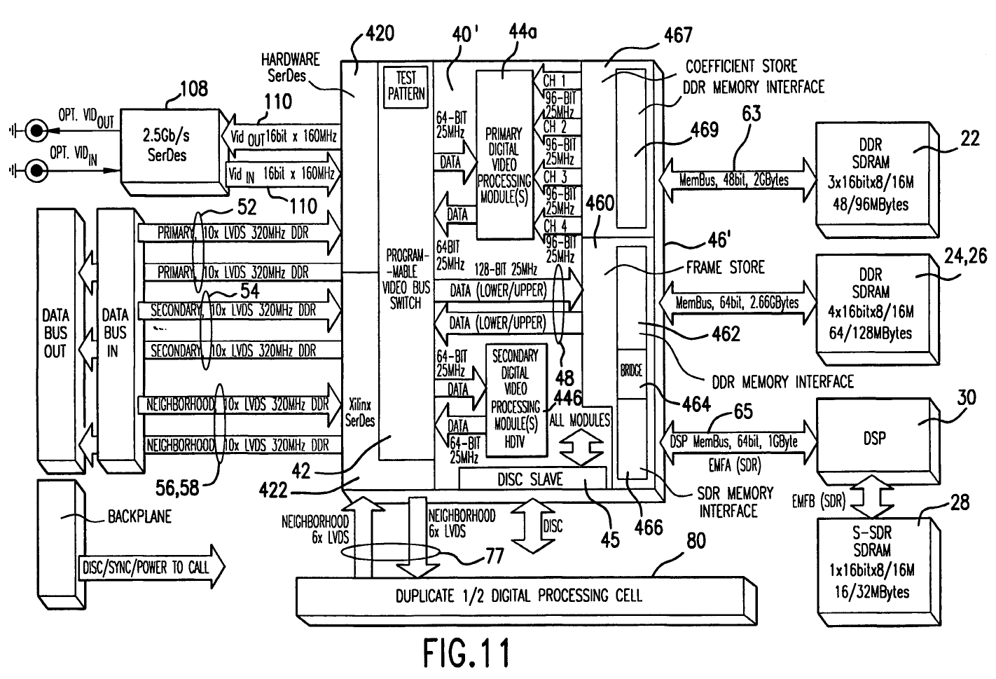

For example, FIG. 11 illustrates another alternative embodiment of a digital processing cell 10″. In the embodiment shown, odd and even frame buffers 24, 26 share a combined memory bus. The digital processing cell 10″ includes an FPGA 40′ with two digital video processing modules, primary digital processing module 44a and secondary digital video processing module 44b. The memory interface 46′ is depicted with a frame store 460 associated with a DDR memory interface 462, a SDR memory interface 466 and a bridge 464 between DDR memory interface 462 and SDR memory interface 466. The memory interface 46′ is also shown with a coefficient store 467 associated with a DDR memory interface 469. Programmable bus switch 42 is also shown with two serializer-deserializers 420 and 422. The digital processing cell 10″ also includes a disc slave 45, connecting the digital processing cell 10″ to a disc for storage of processed video output. Components (FPGA, DSP, connectors, . . . ) can be used from different vendors as long as they meet the digital processing requirements (bandwidth, crunching power for algorithms to be implemented, number of I/Os, . . . ). As new generations with improved performance become available, they can be used to upgrade the overall performance and/or simplify some of the interface requirements.

FGPA generally means Field Programmable Gate Arrays. However, as used herein it may also include custom circuits on a chip with a variety of architectures, including components such as microprocessors, ROMs, RAMs, programmable logic blocks, programmable interconnects, switches, etc.

Image processing systems, such as depicted in FIG. 3, are preferably controlled centrally for synchronization and flexibility, for example, by a microprocessor (not shown). Other control means may be used such as means for controlling the system to perform the algorithms illustrated in FIGS. 4-9, as indicated by controller 209 in FIG. 3.

Having described preferred embodiments of a novel digital processing cell (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and particularity required by the patent laws, what is claimed and desired protected by Letters Patent is set forth in the appended claims.

What is claimed is:

1. A digital image processing method that provides pixel based image correction, comprising the steps of:
a first sub-module of a digital processing cell receiving a first set of pixels;
the first sub-module processing the received first set of pixels;
duplicating a sub-set of the first set of pixels over a neighborhood bus, wherein the neighborhood bus routs data between the first sub-module and a second sub-module of the digital processing cell;
the second sub-module receiving a second set of pixels, wherein the received second set of pixels includes the duplicated sub-set of the first set of pixels; and
the second sub-module processing the received second set of pixels.

2. The digital image processing method of claim 1, wherein the digital processing cell includes a gate array and a signal processor, wherein the first sub-module processing step includes the steps of:
processing a first separate module of an algorithm in the gate array; and
processing a second separate module of the algorithm in the signal processor.

3. The digital image processing method of claim 1, wherein the second sub-module processing step includes the step of deleting a sub-set of the second set of pixels.

4. The digital image processing method of claim 1, wherein the second sub-module receiving step includes the steps of:
receiving an input set of pixels from an image sensor;
receiving the duplicated sub-set of the first set of pixels from the neighborhood bus; and
concatenating the duplicated sub-set of the first set of pixels to the input set of pixels to form the second set of pixels.

5. The digital image processing method of claim 1, wherein the digital processing cell is a first digital processing cell and the method further comprises the steps of:
duplicating a sub-set of the second set of pixels over the neighborhood bus, wherein the neighborhood bus routs data between the first digital processing cell and a second digital processing cell;
the second digital processing cell receiving a third set of pixels, wherein the received third set of pixels includes the duplicated sub-set of the second set of pixels; and
the second digital processing cell processing the received third set of pixels.

6. The digital image processing method of claim 1, wherein the first set of pixels is a 1024 pixel input array.

7. The digital image processing method of claim 1, wherein the sub-set of the first set of pixels is at least 16 pixels.

8. The digital image processing method of claim 1, wherein the sub-set of the first set of pixels is at least 24 pixels.

9. The digital image processing method of claim 1, wherein the sub-set of the first set of pixels is at least 32 pixels.

10. The digital image processing method of claim 1, wherein the sub-set of the first set of pixels is at least 48 pixels.

11. The digital image processing method of claim 1, wherein the sub-set of the first set of pixels is at least 9 pixels.
